(19) United States
(12) Patent Application Publication
(10) Pub. No.: US 2023/0098028 A1
(43) Pub. Date: Mar. 30, 2023

(54) SYSTEMS AND METHODS FOR OPTIMIZING GRAIN SUPPLY NETWORK

(71) Applicant: Cargill, Incorporated, Wayzata, MN (US)

(72) Inventors: Ricardo dos Santos Andrade de ALCANTARA, Sao Paulo (BR); Chris DOMNISORU, Eden Prairie, MN (US); Raphael Pereira de FARIA, Sao Paulo (BR); Max Soares FERREIRA, São Paulo (BR); Leandro Henrique GREGORIO, Sao Paulo (BR); Enrique Javier MORINIGO, São Paulo (BR); Giulia Dugatto SCHMITZ, Sao Paulo (BR)

(73) Assignee: Cargill, Incorporated, Wayzata, MN (US)

(21) Appl. No.: 17/936,421

(22) Filed: Sep. 29, 2022

Related U.S. Application Data
(60) Provisional application No. 63/249,898, filed on Sep. 29, 2021.

(51) Int. Cl. G06Q 10/04

(52) U.S. Cl. CPC G06Q 10/04; G06Q 50/02

(57) ABSTRACT

Systems and methods for optimizing grain supply network can include predicting a volume of a product from each of a plurality of origination sites, predicting a quality of the product from each of the plurality of origination sites, determining one or more constraints for blending the product from the plurality of origination sites to obtain a blended product, and generating a total volume of the product to be used from at least one of the plurality of origination sites for obtaining the blended product such that the blended product is of the desired combined volume and the quality level. The one or more constraints comprises at least a desired combined volume and a quality level. The total volume is determined based on the predicted volume of the product and the predicted quality of the product from each of the plurality of origination sites.

### CROSS-REFERENCE TO RELATED APPLICATIONS

This application claims the benefit of U.S. Provisional Patent Application No. 63/249,898, filed 29 Sep. 2021, which is hereby incorporated by reference in its entirety.

### BACKGROUND

There are many factors that determine the volume and quality of harvested crops of grains such as soybean and corn. For example, the crops are produced all around the world, at different times of the year, and in different climates. Further, each of the farmers that produce the crops may have different contractual requirements with various grain processing facilities which affect how much they produce. And there are different laws in different countries that require a certain mixture and/or blend of the crops before it may be sold to consumers.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

In accordance with some embodiments of the present disclosure, a method is disclosed. The method includes predicting, by a processor executing computer-readable instructions, a volume of a product from each of a plurality of origination sites, predicting, by the processor, a quality of the product from each of the plurality of origination sites, determining, by the processor, one or more constraints for blending the product from the plurality of origination sites to obtain a blended product, the one or more constraints comprising at least a desired combined volume and a quality level, and generating, by the processor, a total volume of the product to be used from at least one of the plurality of origination sites for obtaining the blended product such that the blended product is of the desired combined volume and the quality level. The total volume is determined based on the predicted volume of the product and the predicted quality of the product from each of the plurality of origination sites.

In accordance with further embodiments of the present disclosure, a non-transitory computer-readable medium having computer-executable instructions stored thereon is disclosed. The computer-readable instructions when executed by at least one processor cause the at least one processor to predict a volume of a product from each of a plurality of origination sites, predict a quality of the product from each of the plurality of origination sites, determine one or more constraints for blending the product from the plurality of origination sites to obtain a blended product, and generate a total volume of the product to be used from at least one of the plurality of origination sites for obtaining the blended product such that the blended product is of the desired combined volume and the quality level. The one or more constraints comprises at least a desired combined volume and a quality level. The total volume is determined based on the predicted volume of the product and the predicted quality of the product from each of the plurality of origination sites.

In accordance with further embodiments of the present disclosure, a system is disclosed. The system includes a memory having computer-executable instructions stored thereon and a processor that executes the computer-executable instructions to predict a volume of a product from each of a plurality of origination sites, predict a quality of the product from each of the plurality of origination sites, determine one or more constraints for blending the product from the plurality of origination sites to obtain a blended product, and generate a total volume of the product to be used from each of the plurality of origination sites for obtaining the blended product such that the blended product is of the desired combined volume and the quality level. The one or more constraints comprises at least a desired combined volume and a quality level. The total volume is determined based on the predicted volume of the product and the predicted quality of the product from each of the plurality of origination sites.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 illustrates an example block diagram of a computing system, in accordance with embodiments of the present disclosure.

FIG. 2 illustrates an example block diagram of an optimization system (or mix and blend system) implemented by the computing system of FIG. 1, in accordance with some embodiments of the present disclosure.

FIG. 3 illustrates an example flow chart outlining operations of the optimization engine of FIG. 2, in accordance with some embodiments of the present disclosure.

FIG. 4 illustrates an example flow chart outlining operations for predicting a volume of production of grain from an origination site, in accordance with some embodiments of the present disclosure.

FIG. 5A illustrates an example graph showing changes in volume of grain over time at an example origination site, in accordance with some embodiments of the present disclosure.

FIG. 5B illustrates an example graph showing predictions of a volume of grain using historical data from FIG. 5A, in accordance with some embodiments of the present disclosure.

FIG. 6 illustrates an example flow chart outlining operations for predicting a moisture level of grain from an origination site, in accordance with some embodiments of the present disclosure.

FIG. 7 illustrates an example flow chart outlining operations for predicting a damage level of grain from an origination site, in accordance with some embodiments of the present disclosure.

FIG. 8 illustrates an example flow chart outlining operations for predicting an impurity level of grain from an origination site, in accordance with some embodiments of the present disclosure.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

Grains or crops such as soybean, corn, wheat, etc. may be grown at a variety of locations and in different climates. Because there are many factors that may affect how the crops are grown, each location may produce crops of different volumes and quality. For example, quality of soybean that is grown in a humid climate may be different than the quality of soybean that is grown in a dryer climate. As another example, soybean that is closer to highways or mountains may have more sediment mixed into the harvested collection than soybeans that are grown in remote locations, and therefore be of varying qualities. Further, various farmers (e.g., origination sites) may have contracts for supplying crops of varying volumes in a given harvest season. A food processor may collect crops of different qualities and different volumes from different farmers (e.g., origination sites) and process them before they are ultimately shipped to one or more consumers.

The food processor may mix and blend crops from different farmers to achieve a desired volume and quality of the crop. For example, in some embodiments, a consumer may require a particular volume of soybean and further require that the volume have no more than 14% moisture content. In such cases, depending upon the volume of soybean that is available from various farmers and the moisture level in soybean collected from the various farmers, the food processor may need to mix or blend crops from multiple farmers to achieve the desired volume and moisture content of 14%. Similar requirements may exist for damage and impurity level of the crops. Occasionally, the crops that are too moist may need to be dried before they are mixed/blended, which may impact the volume of crops that may be available from a particular farmer. This task of managing the production, transportation, drying, and mixing/blending may be very complicated and difficult.

In some cases, the process of managing the above tasks may be done manually. Such manual management may lead to excessive delivery times, wasted crops, human error in determining how much volume and of what quality is available, and how to mix and blend crops from various farmers, etc. Accordingly, there is a need to efficiently manage the production, transportation, drying, and mixing/blending of crops in shorter periods of time so that production is greater and cost is lower.

Further, in some cases, as the weather changes, the quality and volume of crops produced from a location may vary. For example, in some cases, a location may produce crops with lower moisture content during dry months and crops with higher moisture content during wet months. Thus, the quality of the crops may continuously vary depending upon local conditions. Problems in the supply chain may also disrupt the amount of volume of crops available. Thus, the volume and quality of crops that are available may be constantly changing.

The present disclosure provides technical solutions that enable accurately predicting the volume of crops that may be available, as well as facilitating the blending/mixing of crops from various farmers to achieve a desired volume and quality. The technical solutions of the present disclosure use current and historical data from each farmer/origination site to predict the volume and quality of crops in the future using machine learning/artificial intelligence. Based on the predicted volume and quality, the present disclosure provides technical solutions to output available volume of crops, and volume of crops from various locations that need to be mixed/blended to achieve a desired overall volume and quality level. Thus, the present disclosure provides an optimization engine that is configured to optimize the overall volume and quality level of crops. The optimization engine may receive data from one or more prediction models. For example, the prediction models may include a volume prediction model (predicting volume of crops), a moisture level prediction model (predicting a moisture level of crops), a damage level prediction model (predicting damage level of crops), and an impurity level prediction model (predicting impurity level such as sediment in crops).

The optimization engine may receive the outputs of one or more of these models and provide recommendations for volumes of crop that need to be mixed from various locations to achieve a desired volume/quality. For example, if one crop from one location has a volume of 1 ton of soybeans with a moisture level that is 5% above a desired limit, the optimization engine may recommend that the crop be mixed with soybean from another location that has 1 ton of soybean with a moisture level that is 5% below the desired limit so that the resulting mixture/blend includes 2 tons of soybeans with moisture level at the desired limit.

The disclosure below is described with respect to soybean simply for the sake of clarity and simplicity, but embodiments are not limited thereto. The present disclosure may be equally applicable to any food item (or product or pre-processed food), such as soybean, corn, wheat, meats, etc. In some embodiments, the present disclosure may be used for non-food items where products from different sources need to be mixed together or where accurate predictions of volume are needed.

The disclosure below is described with respect to three quality parameters: moisture level, damage level, and impurity level for the sake of clarity and simplicity, but embodiments are not limited thereto. The present disclosure may be equally applicable to other quality parameters (such as percentage of protein content) that may be relevant (e.g., depending upon the type of grain), or use fewer quality parameters than the three used herein. In some embodiments, each quality parameter in a blend may be a weighted average of the respective parameter's level that are part of the blend.

The disclosed optimization system advantageously reduces overall processing times because the optimization engine is able to predict how to mix the crops from different sources. Also, there is less waste of the crop because the optimization system is able to output volumes that maximize the throughput. There is also increased efficiency due to reduction of mistakes caused by human error. Furthermore, the food processor is able to plan ahead by predicting how much of what quality crop it may expect from any farmer. The optimization system is also able to be tailored to different requirements such as local laws and/or policies.

Further, “food processors” include any entity that receives crops from various locations, farmers, or origination sites, and mixes/blends crops from these locations/farmers/origination sites to achieve a desired volume and quality level. The “food processor” may supply the blended crops to other entities (e.g., distributors) for eventual sale to consumers. Further, in the present disclosure, an “origination site” includes any location, farmer, or entity where the crop is produced, such as a farm, ranch, vineyard, orchard, garden, etc. or from where crop is supplied to the food processor. The origination site may be located anywhere geographically. Furthermore, in the present disclosure, a destination may include any intermediate or final location where the crop is transported or shipped, such as a processing facility, a distribution plant/facility, a factory, a grain elevator, a country elevator, a warehouse, etc., and any of these terms may be used interchangeably, depending on the context.

Additionally, the terms “mix” and “blend” are used interchangeably herein. The terms “mix” and “blend” mean that crops from different locations/batches may be combined together to achieve a desired volume and quality level of the crops.

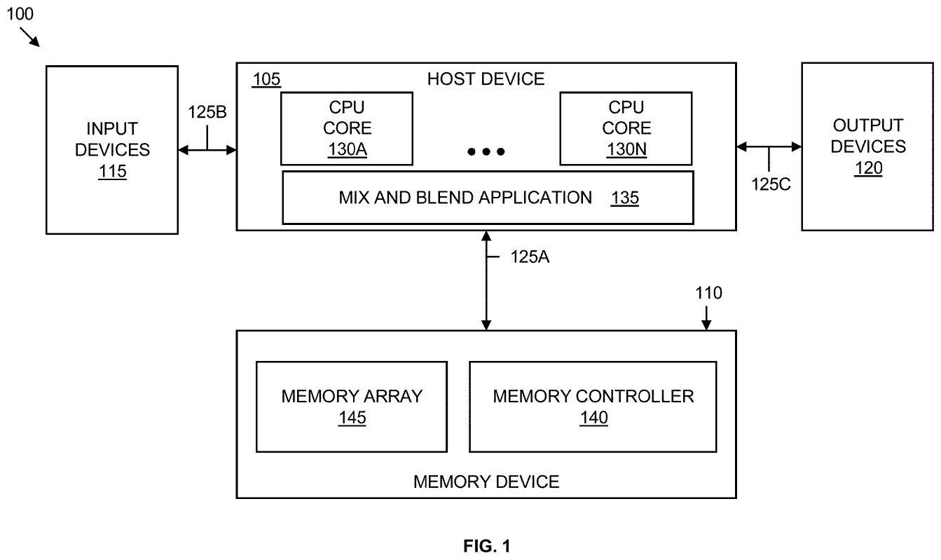

FIG. 1 illustrates an example block diagram of a computing system 100, in accordance with embodiments of the present disclosure. The computing system 100 may be used by a soybean processing manager for optimizing the process of mixing and blending soybean products. The computing system 100 includes a host device 105 associated with a memory device 110. The host device 105 may be configured to receive input from one or more input devices 115 and provide output to one or more output devices 120. The host device 105 may be configured to communicate with the memory device 110, the input devices 115, and the output devices 120 via appropriate interfaces 125A, 125B, and 125C, respectively. The computing system 100 may be implemented in a variety of computing devices such as computers (e.g., desktop, laptop, servers, data centers, etc.), tablets, personal digital assistants, mobile devices, other handheld or portable devices, or any other computing unit suitable for performing standard cell layout using the host device 105.

The input devices 115 may include any of a variety of input technologies such as a keyboard, stylus, touch screen, mouse, track ball, keypad, microphone, voice recognition, motion recognition, remote controllers, input ports, one or more buttons, dials, joysticks, and any other input peripheral that is associated with the host device 105 and that allows an external source, such as a user (e.g., a soybean processing facility manager), to enter information (e.g., data) into the host device and send instructions to the host device. Similarly, the output devices 120 may include a variety of output technologies such as external memories, printers, speakers, displays, microphones, light emitting diodes, headphones, video devices, and any other output peripherals that are configured to receive information (e.g., data) from the host device 105. The “data” that is either input into the host device 105 and/or output from the host device may include any of a variety of textual data, signal data, prediction model data, volume data, quality data, graphical data, combinations thereof, or other types of analog and/or digital data that is suitable for processing using the computing system 100.

The host device 105 includes or is associated with one or more processing units/processors, such as Central Processing Unit (“CPU”) cores 130A-130N. The CPU cores 130A-130N may be implemented as an Application Specific Integrated Circuit (“ASIC”), Field Programmable Gate Array (“FPGA”), or any other type of processing unit. Each of the CPU cores 130A-130N may be configured to execute instructions for running one or more applications of the host device 105. In some embodiments, the instructions and data needed to run the one or more applications may be stored within the memory device 110. The host device 105 may also be configured to store the results of running the one or more applications within the memory device 110. Thus, the host device 105 may be configured to request the memory device 110 to perform a variety of operations. For example, the host device 105 may request the memory device 110 to read data, write data, update or delete data, and/or perform management or other operations. One such application that the host device 105 may be configured to run may be a mix and blend application 135. The mix and blend application 135 may be part of a computer aided design or electronic design automation software suite that may be used by a user of the host device 105 to monitor and optimize the full process of collecting and processing information about soybeans. Specifically, the mix and blend application 135 may be configured to receive data about certain batch of soybeans from multiple origination sites and provide recommendations on how to mix certain crops of soybeans with other crops. For example, if one crop of soybeans has 1 ton of soybeans with moisture level that is 5% above a desired limit, the mix and blend application 135 may recommend that the crop be mixed with another crop of soybeans that has 1 ton of soybeans with a moisture level that is 5% below the desired limit so that the resulting mixture/blend includes 2 tons of soybeans with moisture level at the desired limit. In some embodiments, the instructions needed to execute or run the mix and blend application 135 may be stored within the memory device 110. The mix and blend application 135 may be executed by one or more of the CPU cores 130A-130N using the instructions associated with the mix and blend application from the memory device 110.

Referring still to FIG. 1, the memory device 110 includes a memory controller 140 that is configured to read data from or write data to a memory array 145. In some embodiments, the memory array 145 may include types of volatile and/or non-volatile memories. For example, in some embodiments, the memory array 145 may also include NAND flash memory cores, NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the memory array. Generally speaking, the memory array 145 may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

The memories within the memory array 145 may be individually and independently controlled by the memory controller 140. In other words, the memory controller 140 may be configured to communicate with each memory within the memory array 145 individually and independently. By communicating with the memory array 145, the memory controller 140 may be configured to read data from or write data to the memory array in response to instructions received from the host device 105. Although shown as being part of the memory device 110, in some embodiments, the memory controller 140 may be part of the host device 105 or part of another component of the computing system 100 and associated with the memory device. The memory controller 140 may be implemented as a logic circuit in either software, hardware, firmware, or combination thereof to perform the functions described herein. For example, in some embodiments, the memory controller 140 may be configured to retrieve the instructions associated with the mix and blend application 135 stored in the memory array 145 of the memory device 110 upon receiving a request from the host device 105.

It is to be understood that only some components of the computing system 100 are shown and described in FIG. 1. However, the computing system 100 may include other components such as various batteries and power sources, networking interfaces, routers, switches, external memory systems, controllers, etc. Generally speaking, the computing system 100 may include any of a variety of hardware, software, and/or firmware components that are needed or considered desirable in performing the functions described herein. Similarly, the host device 105, the input devices 115, the output devices 120, and the memory device 110 including the memory controller 140 and the memory array 145 may include other hardware, software, and/or firmware components that are considered necessary or desirable in performing the functions described herein.

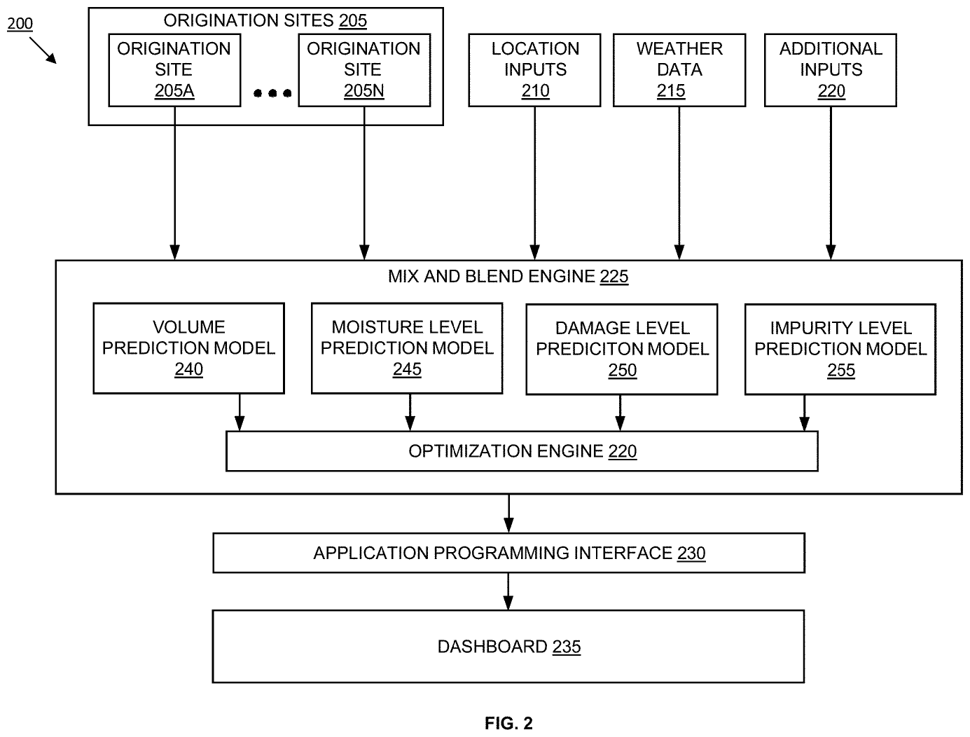

FIG. 2 illustrates an example block diagram of an optimization system 200 (or mix and blend system) implemented by the computing system of FIG. 1, in accordance with some embodiments of the present disclosure. The optimization system 200 may be implemented by the mix and blend application 135 of FIG. 1. The optimization system 200 may be used by a food processor that manages a flow of the soybean distribution and processing. The optimization system 200 may receive a plurality of inputs. For example, the optimization system 200 may receive inputs from origination sites 205A-205N (collectively origination sites 205), location inputs 210, weather data 215, and additional inputs 220. The optimization system 200 may also include a mix and blend engine 225, an application programming interface 230, and a dashboard 235.

Soybeans may be grown at, or supplied from, various origination sites (e.g., the origination sites 205). A food processor may have contracts with these origination sites to receive soybean of a designated quantity (e.g., volume) during a given harvest season. Thus, the food processor may receive soybean from multiple origination sites, and each origination site may supply a designated volume of soybean. The food processor may also have agreements with other entities (e.g., distributors) to supply soybean of a designated volume and quality level. To obtain the designated volume and quality level to be supplied, the food processor may mix soybean from one or more of the origination sites 205. Upon mixing to obtain the designated volume and quality level, the food processor may ship the soybean to the other entity (e.g., distributor).

Further, the soybean from each of the origination sites 205 may be of a particular quality. In general, quality of soybean may be defined in terms of three factors: moisture level, damage level, and impurity level. In some embodiments, the moisture level may mean the amount of moisture (e.g., in percentage) in each (or predetermined number of) grain(s) of soybean. In some embodiments, a specific moisture level may be desired. For example, in some embodiments, an overall moisture level of 14% or less may be desired. In some embodiments, soybean from each origination site may be associated with a moisture level that may, in some embodiments, be an average (e.g., weighted average) of the moisture level in the soybean grains making up the batch. In some embodiments, damage level may mean the amount of soybean (e.g., in percentage) that is diseased, dead, have worms, etc. In some embodiments, a specific damage level may be desired. For example, in some embodiments, an overall damage level of less than 8% may be desired. In some embodiments, soybean from each origination site may be associated with a damage level that may, in some embodiments, be an average (e.g., weighted average) of the damage level in the soybean grains making up the batch. In some embodiments, impurity level may mean the amount of soybean (e.g., in percentage) that includes rocks, dirt, sediment, or other debris (e.g., things that are not soybean). In some embodiments, a specific impurity level may be desired. For example, in some embodiments, an impurity level of less than 1% may be desired. In some embodiments, soybean from each origination site may be associated with an impurity level that may, in some embodiments, be an average (e.g., weighted average) of the impurity level in the soybean grains making up the batch.

In some embodiments, the mix and blend engine 225 may be configured to predict the volume of soybean received from each of the origination sites 205 over a predetermined time period (e.g., day to day basis through a harvest season). In some embodiments, the mix and blend engine 225 may also be configured to predict a moisture level, damage level, and impurity level of soybean received from each of the origination sites 205. To predict the volume, moisture level, damage level, and impurity level of soybean, the mix and blend engine 225 receives a plurality of inputs. For example, the mix and blend engine 225 may receive data about the origination sites 205, such as name of the origination site, type of crop (e.g., soybean) being supplied by that origination site, contracted upon volume and quality of soybean to be supplied by the origination site with a designated time period, supply chain constraints associated with the origination site (e.g., type of equipment that origination site has to store, process, transport, etc. soybean), revenue and other contractual details of the origination site, historical volume and quality of soybean provided from the origination site, and any other details that may be needed or considered desirable to have.

The inputs may also include the location inputs 210. In some embodiments, the location inputs 210 may include the location data of the origination sites 205 that supply soybean. In some embodiments, the location data may include latitude and longitude coordinates of the origination sites 205, the distance between a particular origination site and the food processor, real time traffic information, route taken from the origination site to the food processor location where the mixing/blending operation is to occur, location of ports (e.g., shipping ports) where soybean from the food processor is to be shipped, and any other location related data that may be needed or considered desirable to have in making the predictions discussed herein.

The inputs may also include the weather data 215. The weather data 215 may include weather (or climate) information at the origination sites 205 or weather information along any route through which soybean is transported from the origination sites 205. In some embodiments, a geo-fence may be created around each of the origination sites 205. The weather data 215 may include weather information in the area within the geo-fence. In some embodiments, the weather data 215 may include temperature data, precipitation data, wind data, humidity data, and any other type of weather information that may be needed or considered useful to have. In some embodiments, each of the origination sites 205 may be associated with a zip code or address. The weather data 215 may include weather information in that zip code or at that address. In other embodiments, the weather data 215 for each of the origination sites 205 may be determined in other ways. The weather data 215 may include historical weather data from each of the origination sites 205, current weather data, and forecast weather data. The weather data 215 may be obtained through a weather station that monitors the weather of a certain or multiple geographical regions. As discussed below, the weather data may be used to predict a quality of soybean from a particular origination site 205.

The additional inputs 220 may include any additional input that may be helpful in predicting the volume and/or quality of the batches. For example, additional inputs 220 may include origination site info, amount of soybean being supplied, type of soybean supplied by each origination site, capacity of shipment from each farmer, supply chain constraints, farmer constraints (e.g., whether the farmer can ship, how long does farmer take to get to a port for shipment), desired blend and quality constraints, etc. Additional inputs 220 may also include traffic information such that the mix and blend engine 225 may obtain information about whether a particular delivery truck will run into traffic enroute to the food processor. The additional inputs 220 may also include information related to the desired volumes and/or quality levels of soybean for each entity for which the soybean is to be mixed/blended. Other additional inputs 220 that may be needed or considered useful to have in making the predictions described herein may be provided.

The mix and blend engine 225 may be used to provide recommendations on how to mix and blend the soybean from the origination sites 205. The mix and blend engine 225 may include one or more prediction models including a volume prediction model 240, a moisture level prediction model 245, a damage level prediction model 250, and an impurity level prediction model 255. Outputs from the volume prediction model 240, the moisture level prediction model 245, the damage level prediction model 250, and the impurity level prediction model 255 may be used as inputs to the optimization engine 220.

The volume prediction model 240 may predict an amount of soybean that is expected to be received from a particular one of the origination sites 205. The moisture level prediction model 245 may predict a moisture level of the soybean from a particular one of the origination sites 205. The damage level prediction model 250 may predict a damage level of the soybean from a particular one of the origination sites 205. And the impurity level prediction model 255 may predict an impurity level of the soybean from a particular one of the origination sites 205. In some embodiments, the prediction from each of the volume prediction model 240, the moisture level prediction model 245, the damage level prediction model 250, and the impurity level prediction model 255 may be based on current data and historical data.

In some embodiments, predictions from one or more of the volume prediction model 240, the moisture level prediction model 245, the damage level prediction model 250, and the impurity level prediction model 255 may be run daily (or periodically at predetermined intervals) to make predictions for the length of a customizable optimization window (e.g., 15 days). Thus for example, in some embodiments, predictions may be for the next 15 days or whatever the length of the optimization window is. Inventors have determined that an optimal prediction window may be 15 days and that the accuracy of the predictions decrease after 15 days. However, in other embodiments, optimization windows of other periods may be used. In some embodiments, the optimization window may be associated with a delivery date of providing soybeans such that the optimization window may include a predetermined number of days before the delivery date.

Each of the volume prediction model 240, the moisture level prediction model 245, the damage level prediction model 250, and the impurity level prediction model 255 may be implemented using a processor(s) and one or more memory(s) (e.g., similar to the CPU core(s) 130A-130N and the memory device 110). Further, the volume prediction model 240, the moisture level prediction model 245, the damage level prediction model 250, and the impurity level prediction model 255 may be implemented in software, hardware, firmware, or a combination thereof. Although each of the volume prediction model 240, the moisture level prediction model 245, the damage level prediction model 250, and the impurity level prediction model 255 are shown as separate components, in some embodiments, one or more of those components may be combined together into a single component and the single component may perform the operations of the individual components that were combined.

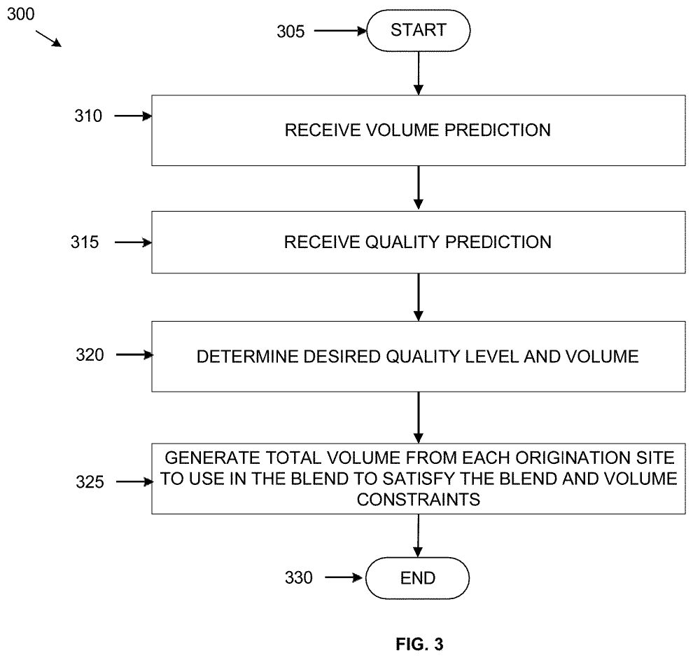

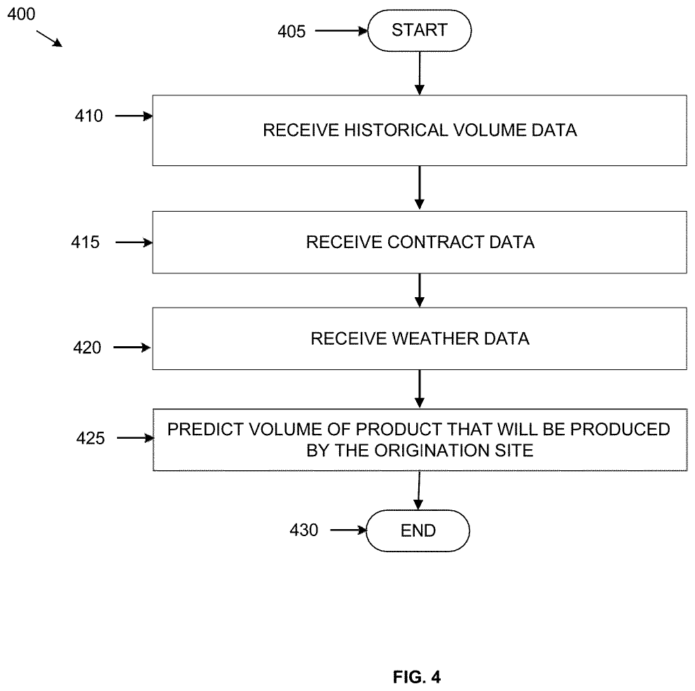

The optimization engine 220 may receive data from each of the volume prediction model 240, the moisture level prediction model 245, the damage level prediction model 250, and the impurity level prediction model 255 and provide recommendations on maximizing gain. For example, the optimization engine 220 may determine total volume of soybean to use from one or more of the origination sites 205 to obtain a desired quality level based on the data received from each of the volume prediction model 240, the moisture level prediction model 245, the damage level prediction model 250, and the impurity level prediction model 255. Specifically, in some embodiments, the optimization engine 220 may include a decision matrix to maximize gain (e.g., maximize volume having a desired quality level). Further details on the optimization engine 220 is provided with reference to FIG. 3, and further details on the prediction models 240-255 are provided in further detail with reference to FIGS. 4-8.

Referring still to FIG. 2, the dashboard 235 may form the front end of the optimization system 200 and the mix and blend engine 225 may form the backend of the optimization system. The optimization system 200 may be accessed via a computing device associated with the computing system (e.g., of FIG. 1). In other embodiments, instead of or in addition to being accessible via a particular computing device, the optimization system 200 or at least portions thereof may be hosted on a cloud service and may be accessed via the cloud. In some embodiments, the optimization system 200 may additionally or alternatively be configured as a mobile application suitable for access from a mobile computing device (e.g., a mobile phone). In some embodiments, the optimization system 200 and particularly the dashboard 235 may be accessed via the Application Programming Interface (“API”) 230. To access the dashboard 235 via the API 230, a user may use designated devices such as laptops, desktops, tablets, mobile devices, other handheld or portable devices, and/or other types of computing devices that are configured to access the API. These devices may be different from the computing device on which the optimization system 200 is installed.

In some embodiments and when the dashboard 235 is configured for access via the API 230, the user may access the dashboard via a web browser and upon entering a uniform resource locator (“URL”) for the API such as the IP address or other indicator of the optimization system 200 or other web address. Using the API 230 and the dashboard 235, the users may then send instructions to the mix and blend engine 225 and receive information back from the mix and blend engine 225. In some embodiments, the API 230 may be a representational state transfer (“REST”) type of API. In other embodiments, the API 230 may be any other type of web or other type of API (e.g., ASP.NET) built using any of a variety of technologies, such as Java, .Net, etc., that is capable of accessing the mix and blend engine 225 and facilitating communication between the users and the mix and blend engine 225. In some embodiments, the API 230 may be configured to facilitate communication via a hypertext transfer protocol (“HTTP”) or hypertext transfer protocol secure (“HTTPS”) type request. The API 230 may receive an HTTP/HTTPS request and send an HTTP/HTTPS response back. In other embodiments, the API 230 may be configured to facilitate communication using other or additional types of communication protocols. In other embodiments, the optimization system 200 may be configured for access in other ways.

The dashboard 235 provides a user interface that facilitates human-computer interaction between the users and the mix and blend engine 225. The dashboard 235 is configured to receive user inputs from the users via a graphical user interface (“GUI”) and transmit those user inputs to the mix and blend engine 225. The dashboard 235 is also configured to receive outputs/information from the mix and blend engine 225 and present the outputs/information to the users via the GUI of the mix and blend engine 225. The GUI may present a variety of graphical icons, windows, visual indicators, menus, visual widgets, and other indicia to facilitate user interaction. In other embodiments, the dashboard 235 may be configured as other types of user interfaces, including for example, text-based user interfaces and other man-machine interfaces. Thus, the dashboard 235 may be configured in a variety of ways.

Further, the dashboard 235 may be configured to receive user inputs in a variety of ways. For example, the dashboard 235 may be configured to receive the user inputs using input technologies including, but not limited to, a keyboard, a stylus and/or touch screen, a mouse, a track ball, a keypad, a microphone, voice recognition, motion recognition, remote controllers, input ports, one or more buttons, dials, joysticks, etc. that allow an external source, such as the user, to enter information into the optimization system 200. The dashboard 235 may also be configured to present outputs/information to the users in a variety of ways. For example, the dashboard 235 may be configured to present information to external systems such as users, memory, printers, speakers, etc. Therefore, although not shown, dashboard 235 may be associated with a variety of hardware, software, firmware components, or combinations thereof. Generally speaking, the dashboard 235 may be associated with any type of hardware, software, and/or firmware component that enables the mix and blend engine 225 to perform the functions described herein. The dashboard 235 (or user interface) may establish a bridge between data, optimization and prediction models, and the user. The user interface may ingest all data required for the optimization model and process all results from the user perspective. The protocol may use API REST endpoints.

Accordingly, the optimization system 200 may provide recommendations on how to combine the batches of soybean that are received from the origination sites 205. The optimization system 200 may minimize the costs associated with unnecessary or roundabout routes of delivery while maintaining standards for the mixture of the soybean. For example, if there are 3 origination sites (the origination sites 205A, 205B, and 205C) which respectively produce soybean batches A, B, and C. The mix and blend engine 225 receives various inputs from the origination sites 205A-205C, the location inputs 210, the weather data 215, and the additional inputs 220. Based on the inputs, the mix and blend engine 225 may make several predictions using the volume prediction model 240, the moisture level prediction model 245, the damage level prediction model 250, and impurity level prediction model 255. For example, using the volume prediction model 240, the mix and blend engine 225 may predict that batch A is expected to include 10 tons, batch B is expected to include 12 tons, and batch C is expected to include 15 tons. Using the moisture level prediction model 245, the mix and blend engine 225 may predict that batch A has a 10% moisture level, batch B has a 18% moisture level, and batch C has a 14% moisture level. The mix and blend engine 225 also knows that an acceptable moisture level for supplying to consumers is 14% or lower. The mix and blend engine 225 may then recommend that the first-third batches A-C be mixed in equal amounts (10 tons each) so that the resulting mixture has a 14% moisture level. If the destination for the mixture of the soybeans has an acceptable moisture level of 12%, the mix and blend engine 225 may determine amounts of the batches A, B, and C so that the resulting mixture has at most 12%, and without exceeding the maximum volume of each of the batches. In some embodiments, similar mixture recommendations may be made to create mixtures that have a maximum of X % impurity level and/or Y % damage level. In some embodiments, the mix and blend engine 225 may recommend that certain batches be dried at the facilities before being mixed with other batches. Also, in some embodiments, the mix and blend engine 225 may redirect the shipment of a batch of soybean to another destination (e.g., a second processing facility) so that the batch may be mixed in with other batches at the second processing facility. Although the above example and in the rest of this disclosure uses certain numbers, these numbers are provided merely as examples and are not intended to be limiting in any way.

Further, in some embodiments, each of the origination sites 205A, 205B, or 205C may be located at different distances from the destination (e.g., the food processor, shipment port, etc.), thus requiring a different time for transportation. For example, the origination site 205A may be located 1 day away from the destination (e.g., may need 1 day to transport soybean from the origination site to the food processor, shipment port, etc.) and the origination site 205B may be located 2 days away from the destination. The optimization system 200 may determine the volume of soybean to ship from each of the origination sites 205 towards the destinations such that, upon arrival at the destination, the weighted average quality/quantity are within the required limits. For example, a shipment of soybean sent from the origination site 205A today may be mixed with another shipment of soybean shipped from the origination site 205B tomorrow to form the mix and blend at the destination within the same day of arrival.

The optimization system 200 may recommend that a variety of combination of mixtures in quantity (e.g., how much of one batch to mix with how much of another batch), time (e.g., a first batch received on a first day may be mixed with a second batch received on the same or different day), and quality (e.g., soybeans having a certain quality may be mixed with soybeans having a different quality so that the end result is a soybean mixture that meets specifications). For example, the optimization system 200 may recommend that the soybeans received on a first day from origination site 205A be mixed/blended with soybeans received on a second day (e.g., next day) from another origination site (e.g., origination site 205B). As another example, the soybeans received on a first day from one origination site (e.g., origination site 205A) may be combined with soybeans from the same origination site (e.g., origination site 205A) on a second day. The optimization system 200 may make such recommendations based on the outputs of the prediction models 240-255 and a determination that mixing/blending the soybeans in this manner may produce a mixture/blend of soybeans that maximizes the production of the soybeans at the processing facility and minimizes the waste of soybeans. In other words, the optimization system 200 may determine that mixing in this manner may provide a volume and a quality of the soybeans that are more optimal than, for example, mixing soybeans from origination site A with soybeans from origination C received on the same day or different days. Although the examples here only describe mixing two batches, but embodiments are not limited thereto, and the optimization system 200 may recommend mixing more than two batches that are received from multiple origination sites across multiple days.

As another example, the optimization system 200 may make an example recommendation in the following manner. On day 0, the optimization system 200 may make a forecast/recommendation about the various batches of soybeans within a grain supply network. The recommendation may indicate that on day 1, the soybeans received (e.g., at a first processing facility) have a 16% moisture level and these soybeans do not need to be dried. The recommendation may also indicate that on day 2, the soybeans received (e.g., at a second processing facility) have 13% moisture level (and do not need to be dried). The recommendation may further indicate that on day 3, the soybeans received (e.g., at a third processing facility) have a 12% moisture level. Then the recommendation may indicate that these three batches of soybeans may be mixed to create a batch of soybeans with 13.5% moisture level.

It is to be understood that only some of the elements of the optimization system 200 are shown and described herein. Nevertheless, other elements that may be needed or considered desirable to have in performing the operations herein may be provided in the optimization system 200. Further, although not shown, the optimization engine 220 may be implemented in software, hardware, firmware, or combination thereof, and may be associated with one or more processors and memory(ies). In some embodiments, the optimization engine 220 may be combined with one or more of the volume prediction model 240, the moisture level prediction model 245, the damage level prediction model 250, and the impurity level prediction model 255.

Referring to FIG. 3, an example flow chart outlining the operations of a process 300 performed by the optimization system 200 of FIG. 2 is shown, in accordance with some embodiments of the present disclosure. The process 300 may be implemented by the optimization engine 220 to generate an optimum blend of soybean based on desired volume and quality level. It is noted that the process 300 is merely an example, and is not intended to limit the present disclosure. Accordingly, it is understood that additional operations may be provided before, during, and after the process 300 of FIG. 3, and one or more of the operations in the process 300 as shown in FIG. 3 may be removed or modified, depending on embodiments.

The process 300 starts at operation 305. At operation 310, the optimization engine 220 receives a volume prediction of soybean from one or more of the origination sites 205. The optimization engine 220 may receive the volume prediction based on a determination made using the volume prediction model 240. The volume prediction model 240 may receive several inputs, such as historical volume data, contract data, and/or weather data. The output of the volume prediction model 240 is received as an input by the optimization engine 220. Further details on the volume prediction model 240 are described below with reference to FIG. 4.

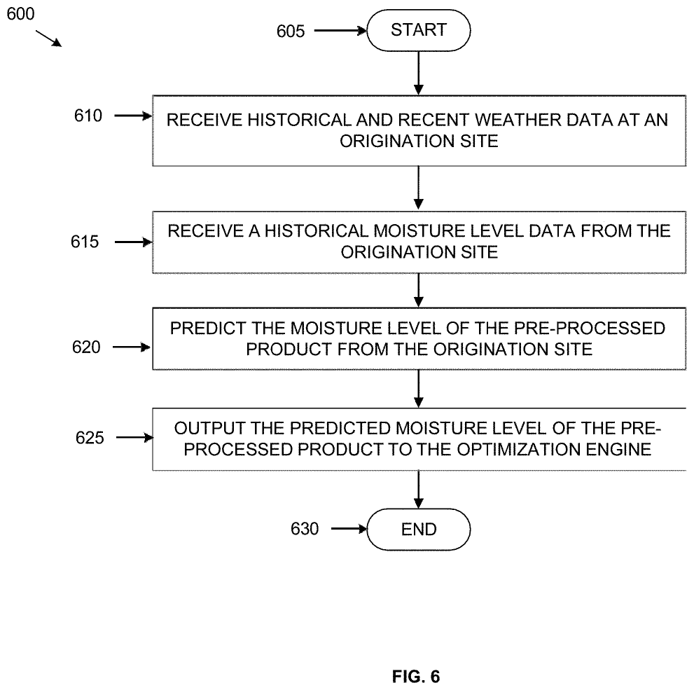

At operation 315, the optimization engine 220 receives a quality prediction of soybean from each of the origination sites 205 (e.g., the origination sites whose volume prediction was received at the operation 310). As discussed above, the quality prediction may include one or more of the moisture level via the moisture level prediction model 245, the damage level via the damage level prediction model 250, and/or the impurity level via the impurity level prediction model 255. Thus, in some embodiments, the optimization engine 220 may receive predictions from one or more of the moisture level prediction model 245, the damage level prediction model 250, and/or the impurity level prediction model 255. Further details on each of these prediction models are provided below with respect to FIGS. 6-8.

At operation 320, the optimization engine 220 determines the desired quality level and volume. For example, in some embodiments, the optimization engine 220 may need to supply X volume of soybean having a Y quality level to an entity (e.g., distributor). In some embodiments, the optimization engine 220 may receive the desired quality level and volume details from the additional inputs 220. In other embodiments, the optimization engine 220 may receive these details in other ways.

At operation 325, the optimization engine 220 generates a total volume from each of the origination sites to use to obtain the volume (e.g., X) that is desired with the volume having the desired quality level (e.g., Y). The optimization engine 220 may use an optimization model based on a mixed integer linear programming (MILP) model. The optimization model may be understood as a set of restrictions imposed upon the many variables defining the optimization model, together with a complex “cost” function which defines what would cost to adopt the decisions recommended by the optimization model. The optimization model tries to find the combination of variable values such that the cost is minimized. In some embodiments, the optimization model may be based on a Gurobi optimizer. In other embodiments, other types of optimization models may be used.

The volume of soybean during a particular period of time (e.g., a day) and traveling from one point to another between the various components—such as between a pile at a soybean processing facility and the exit from the soybean processing facility, or between each the soybean processing facility and its potential destinations where the soybeans are further processed and/or stored—may be represented by separate variables.

There may be a plurality of piles at the soybean processing facility. For example, the optimization model may coordinate the storage and flow of soybean in and from piles as individual storage entities within each soybean processing facility (or warehouse). The warehouse may have a large number of piles of various kinds, as well as “silo bags” and “silo bunkers,” which are storage areas outside the main warehousing facility and helpful particularly when the harvest is particularly large and the existing storage facilities are not sufficiently large to hold all of the received crop. The types of piles may include: “dry,” “humid,” “damaged,” and “impurities.” The optimization model may not manage the influx (or reception) of volumes of impurities but only attempt to use the reported (by local managers of the origination sites or soybean processing facilities) volume of impurities.

Each pile may be registered with its own defined quality parameters, including a type of grains that could be stored there. If a soybean processing facility does not have any pile registered as “humid” but does have “dry” piles, and is receiving moist soybeans, the optimization model may attempt to dry everything before storing if the soybeans cannot be shipped with that level of moisture level. In some embodiments, because of the type of piles and grain (e.g., dry corn, dry soybeans, humid corn, humid soybeans, etc.), the optimization model may not recommend to store humid corn even if the same soybean processing facility has an empty pile of wet soybeans. In some embodiments, the impurity piles may be registered separately for corn and separately for soybeans so that the corn and soybeans are not mixed together.

In some embodiments, the optimization model may determine the network connectivity (e.g., which soybean processing facilities may ship to which destinations) by examining monthly demand data. If there is no record in the monthly demand list showing a volume allocated from a soybean processing facility to a certain destination, the optimization model may assume there is no connection between them. Then, the optimization model may not include such a connection in the network describing the potential flow of soybean and, as a result, it may not recommend sending soybean from such a soybean processing facility to such a destination.

In some embodiments, a length of an optimization window (e.g., number of hours, days, weeks, etc. for which the optimization may make recommendations) may be a parameter within the optimization model and may be chosen by the calling interface. For example, the optimization model may be used to predict the operations 15 days ahead.

In some embodiments, when certain small soybean processing facilities have limited capacity, or no drying capacity at all, if a list of connected soybean processing facilities where the flow may be redirected is indicated, the optimization model may try to redirect the flow towards those other soybean processing facilities. In some embodiments, there may be an unlimited number of soybean processing facilities connected to the network, so long as the computing system 100 has the processing power and storage to process all the information.

There may be a plurality of constraints on the optimization model to help provide optimization recommendations. In some embodiments, each pile, silo bag, or silo bunker has a maximum storage capacity, and the optimization model cannot recommend storing more in a pile than its maximum storage capacity. In some embodiments, each soybean processing facility has a certain maximum capacity for reception per day (the soybean processing facility cannot physically take any more soybean), and the optimization model cannot recommend receiving (or accept) a larger volume than this. In some embodiments, this capacity may change from one day to another. For example, during weekends, some soybean processing facilities may be closed for operation, and consequently, their reception capacity during those days is zero. In some embodiments, the volume shipped from each soybean processing facility cannot be larger than the capacity for expedition. This may also change from day to day. However, a soybean processing facility may be closed for reception one day, but open for transmission that same day. In some embodiments, each soybean processing facility has a specific drying capacity per day, but this may vary from day to day as well. Occasionally, the driers in a soybean processing facility might be under scheduled maintenance or repairs, and the user may simply specify which days that would be in place. In turn, the model may know it cannot schedule any drying during those days at that facility and, if need be, would attempt to schedule more drying in other locations. In some embodiments, capacity may be determined on a periodic basis for each type of equipment. For example, a soybean processing facility might have 2 driers with a capacity of 120 ton/hour each and scheduled to work 8 hours during day X. Consequently, the drying capacity of this soybean processing facility during day X is 2×120×8=1920 tons.

Each destination has a volume expected (demand) for each day, and the optimization model attempts to deliver fulfill that demand. The destination may include the next and/or final location where the mixed soybeans (e.g., final product) is delivered either for further processing (e.g., packaging, labeling, etc.) or sale to consumers. Each of the destinations demand has specifications for the percentage of moisture level, damage level, and impurity level, and the optimization model may manage all three quality characteristics simultaneously or substantially simultaneously. The optimization model may not attempt to deliver a volume larger than the demand volume, a mixed soybean having a moisture level, damage level, or impurity level above certain predetermined thresholds. If there is not a sufficient volume, or the results of optimization model are constrained by various constraints (e.g., a limited shipping capacity during weekends), the optimization model may attempt to satisfy as much as possible from the demand. The optimization model may manage the volume of soybean scheduled to arrive at each destination daily, as well as the volume in transit (e.g., left an origination site and headed to a soybean processing facility, or left some soybean processing facility and is expected to arrive at a destination). The optimization model may consider the quality parameters of the soybean and transit when determining what to expedite (for example, if the soybean delivery during a particular day is known to have a lower moisture level, the optimization model may attempt to ship soybean with higher moisture level from other soybean processing facilities to arrive at the destination at the same time with the soybean delivery with lower moisture level. In some embodiments, even when there is no or limited demand from a particular soybean processing facility or destination, the optimization model may provide a recommendation to deliver the soybean to the particular soybean processing facility or destination.

For each combination of soybean processing facility, destination, and day (or any other time period such as hour or week), and for each type of quality (moisture, damaged, and impurities), there may be a second set of constraints enforced. For example, even though the general demand at a destination might be for soybean with 15% moisture level, and because of volumes of soybeans coming has a much lower moisture content of (as an example, 13%), the optimization model may attempt to ship soybean with a higher moisture level (e.g., 16%). This “second” type of limit, which may be user-defined, may indicate that from a particular soybean processing facility the optimization model could only send soybean with a moisture content as high as 15.5%. The optimization model may consider this second type of limits for volume, damage level and impurity level as well.

In some embodiments, the immediate few days following the optimization window may be too short of a time to adjust the flow. Therefore, the optimization model may include bias logistics which may help mitigate sudden and drastic changes to the flow of the soybeans in the network. For example, in some embodiments, users (or administrators or managers) of the optimization system 200 may manually direct (or force) the optimization model to specifically ship a predefined set of volumes during the first Y number of days of the optimization window. In some embodiments, the volume of the soybean being delivered to the food processing facility may be the only parameter that is set by the user, but the quality may still calculated and determined as a result of the optimization model. Accordingly, the optimization model may change its recommendations from one day to the next if better opportunities show up. For example, the user may set the bias logistics volume for today for a soybean processing facility to be 1000 tons, but the optimization model may determine where and how to mix the 1000 tons of soybean with the remaining piles of soybeans at the soybean processing facility.

Each pile of soybean may have a maximum number of days the soybean may be stored in it safely (e.g., wet soybean may be stored around 10 days before the soybean starts rotting). If the optimization model receives from the input as parameter that in a certain pile may be stored a limited amount of days that falls within the length of the optimization window, the optimization model may attempt to either ship that soybean, or dry it (if possible) and store it into a dry pile. This action may have the highest priority among others because if not implemented, the pile of soybean may rot. Therefore, if a soybean processing facility has a pile of soybean with high moisture and a small number of days to store, the optimization model may attempt to ship everything from that pile with the highest priority, even if this means that other opportunities are temporarily placed in lower priority. For example, even if there is an opportunity the optimization model to increase the percentage of impurities, the optimization model may still force to expedite cleaner product to limit the loss from the damage that could occur in the wet pile if soybean will remain there past the limit of storage days.

In some embodiments, the optimization model may not recommend taking less than a certain low amount (e.g., 5 tons) from any given pile in any given day with the exception of impurities piles. In some embodiments, a pile including impurities may include a minimum of 50% soybeans. In some embodiments, the optimization model will not recommend to ship less than a certain amount (e.g., 200 tons) of soybean from any origination site towards any soybean processing facility in any given day, except if specifically requested via the bias logistics mechanism, where the logistics team may specify volumes to be moved with high priority above other constraints.

In some embodiments, each destination and/or soybean processing facility may come with a set of quotas in terms of volumes it may accept, in any given day, from a given region (e.g., a certain geographical area). In some embodiments, the optimization model may not send more volume than the specified quota, even if the demand is higher.

In some embodiments, the optimization model may implement a cadence to the flow of soybean shipment. For example, once shipment is started for soybean from an origination site or processing facility, the optimization model may let the shipment continue for a minimum number of days. For example, if the cadence is 3 days and 10% change, then if shipment has begun, the shipment may continue for at least 3 consecutive days, and the change in volume from one day to the next may not be higher than +/−10%.

In some embodiments, while the optimization model attempts to satisfy all demands, the optimization model may also try to prioritize the transportation of impurities, damaged or wet/humid soybeans to ensure that the soybean mixture at the soybean processing facility satisfies the quality parameters expected.

In some embodiments, for each pile or shipment of soybean moving through the network, the optimization model may add or subtract a value representing the cost for delivering the shipment of soybean. For example, a first type of factor may be a perceived cost which evaluates whether or not a certain shipment of soybean needs to be transported because of the quality of the soybean. For example, shipping soybean with higher moisture level may be considered more valuable or higher priority than shipping dry soybean, since the wet soybean needs to be dried or mixed before it rots. In this situation, the optimization model may increase the cost for the wet pile. A second type of factor may be transportation cost which is a calculated cost dependent upon how much the harvested soybean needs to travel in order to reach the destination and/or soybean processing facility. Shipping soybeans to closer soybean processing facilities may have a lower cost than shipping the soybeans to a farther soybean processing facility. A third factor may include a drying cost which includes the cost of drying the wet soybeans. A soybean that does not need to be dried may have the lowest drying cost while the soybeans that need to be dried more may have the higher drying costs.

The optimization model may calculate the various types of costs and try to find a solution that minimizes the cost for the whole network. This calculation and optimization process may include balancing the varying costs. For example, if the drying cost is less than the transportation cost, the optimization model may find a solution that prefers the cheaper solution. For example, when facing a choice between two solutions A and B, where A includes drying more soybean in a nearby location and B includes transporting more dry soybeans from a distant location, the optimization model may recommend a solution based on the difference in cost/benefits between the two. For example, there may be a breaking or inflection point where the transportation cost would be higher than drying locally, and the model may recommend to dry more, even if at the other end of the country there is dry soybean available.

In some embodiments, even if a solution does not recommend additional drying, mixing existing dry soybean with existing wet soybean may help reduce the overall moisture level. If there is a single soybean processing facility to consider as delivering to a destination, then the optimization model may recommend that as much of the wet soybean (from wet piles), or soybean with higher damage level or impurities level from the soybean processing facility be transported and mixed. In some embodiments, if there are multiple soybean processing facilities that may deliver to a destination, the optimization model may consider the relative transportation costs. For example, assume that: (1) there are two soybean processing facilities A and B, (2) soybean processing facility A only has dry soybean and soybean processing facility B only has wet soybean, (3) the transportation cost from B to a destination is higher than the transportation cost from A to the destination (Extra_Cost_from_B (per ton, for example)), and (4) the benefit from bringing wet soybean is Mix_Wet (per ton). In this situation, the optimization model may recommend to bring wet soybean from soybean processing facility B only if Extra_Cost_from_B is less than Mix_Wet. However, the optimization model may be changed such that it recommends bringing wet soybean from farther away, by changing the value of Mix_Wet (per ton). For example, if the value for Mix_Wet is a very high level, the optimization model may recommend bringing the wet soybean from farther away. Similar calculations and optimizations may be performed for damaged soybeans and impurities as well. Further, in some embodiments, the recommendation model may recommend bringing damaged soybeans from far away distances, but for soybeans having a certain or high moisture level or a certain or higher impurity level to be transported distances.

Thus, the optimization engine 220 optimizes the volume of soybean from various ones of the origination sites 205 to achieve a desired volume and quality level. The process 30 ends at operation 330.

FIG. 4 illustrates an example flow chart of outlining operations for predicting a volume of production of soybeans at an origination site, in accordance with some embodiments of the present disclosure. Process 400 may be performed using the volume prediction model 240 of the mix and blend engine 225. It is noted that the process 400 is merely an example, and is not intended to limit the present disclosure. Accordingly, it is understood that additional operations may be provided before, during, and after the process 400 of FIG. 4, and one or more of the operations in the process 400 as shown in FIG. 4 may be removed or modified, depending on embodiments.

The volume prediction model 240 may be configured to determine, out of a contract volume with a given origination site, what quantity of soybean may arrive on any given day. For example, if an origination site has a contract to supply 10,000 tons of soybean during a harvest season, the volume prediction model 240 may forecast what volume of the 10,000 tons is expected from that origination site on each day of the harvest season (e.g., how much on day 1, how much on day 2, and so on). In some embodiments, the volume prediction model 240 may make a prediction for each day during the optimization window.

The volume prediction model 240 may include one or more algorithms or scripts for data preparation, classification and regression machine learning, and statistical equations for fine tuning. For example, the volume prediction model 240 may receive as input precipitation observed and forecast, historical volume receptions data from a particular origination site 205, and the contractual agreement between the origination site 205 and the soybean processing facility/soybean processor. In other embodiments, the volume prediction model 240 may receive other or additional inputs.

At operation 410, the volume prediction model 240 may receive data such as historical volume of the soybeans from a particular origination site. For example, the historical volume may indicate that at this time of year in the past, the origination site produced and harvested X tons of soybean. In some embodiments, the historical volume may include volume data that is organized into periods of time. For example, the historical volume data may indicate that over a period of X weeks or months, the origination site produced and harvested Y tons of soybeans.

At operation 415, the volume prediction model 240 may also receive a contractual agreement as input. The contractual agreement may indicate how much of the soybeans the first origination site (e.g., the farmer) is required to provide by the collection date to the processing facility (e.g., the food or soybean producer). For example, the contractual agreement may provide an indication of an upper or lower limit of how much soybeans is supposed to be provided. The volume prediction model 240 may process the agreements with dynamic balance, like an account balance, summing or discounting tons of grains regarding new signed agreements or receptions fulfilling signed contracts. Further, in some embodiments, “medium term” agreements may be considered, including agreements with an initial and an ending date, on a typical quarterly (three monthly) basis time slot. In some embodiments, “spot buying” transactions may be excluded, which are signed and totally consumed single day agreements, originated by punctual unexpected receptions.

At operation 420, the volume prediction model 240 may receive weather data at the first origination site as an input. How much precipitation there was at or near the first origination site over the last X number of days may indicate how much soybeans the origination site was able to produce during that period. Depending on embodiments, not all of the contractual agreements may be considered, since some agreements may have a short term and may not substantially affect the optimization model.

At operation 425, the volume prediction model 240 may predict, using a machine learning model, the volume of soybeans that will be produced by the origination site, based on the historical volume data, the contractual agreement data, and/or the weather data. In some embodiments, the volume prediction model 240 may include two machine learning models—a classification model and a regression model. In some embodiments, the classification model and the regression model of the volume prediction model 240 may each be implemented using an artificial neural network (ANN) or other types of machine learning algorithms and regularization. For example, in some embodiments, Tensorflow 2.0 and Keras models may be used for either or both of the classification model and the regression model. In other embodiments, other types of classification model and the regression model may be used.

Furthermore, the volume prediction model 240 may include statistical equations for fine tuning the outcome predictions based on the concept of expected value. In some embodiments, a convolutional neural network (CNN) may be used with time series. For example, in some embodiments, Facebook Prophet library may be used. In other embodiments, other models may be used. By using the time series, the volume prediction model 240 may predict seasonal volumes of a particular crop. The volume prediction model 240 may predict the trending for the current crop from a particular origination site which may be used to predict the volume of production from the particular origination site and/or for data analysis.

In some embodiments, the machine learning models may be trained prior for making the volume predictions. In some embodiments, to train a machine learning model, sample data may be used. In some embodiments, the sample data may include available past data that may be divided into training data set and testing data set. The machine learning model may be trained with the training data set and tested with the test data set. In some embodiments, the machine learning models that provide optimal results with the testing data set may be selected for making the predictions. In some embodiments, the machine learning models may be retrained. For example, in some embodiments, the machine learning models may be retrained with additional training data sets at least prior to each major harvest season and retested with additional test data sets that may have become available since the last training. In this way, naturally occurring shifts into the correlations between the predicted variables and input data may be accounted for and detected and incorporated gradually. By virtue of continually training the machine learning models, the accuracy of predictions of the machine learning models may be continuously refined and improved.

In some embodiments, the machine learning models may be trained with different set of algorithms against a training data set and test data set. In some embodiments, the algorithm which yields the best results on test data may be selected for the machine learning models. Thus, in some embodiments, the machine learning models may be trained with different set of test/training data sets and/or using different machine learning/artificial intelligence algorithms.

Further, in some embodiments, as part of training the machine learning models, the weights that are applied to the various inputs may be modified. In other words, the weights may be dynamic. Specifically, some inputs may contribute more to the volume prediction than other inputs. To quantify the effect of the differences in these inputs, different weights may be assigned to each input (also referred to herein as an “attribute”). For example, in some embodiments, certain inputs may be accorded a higher weight than other inputs. In some embodiments, the weights that are used during training the machine learning models may be determined internally by the neural network (e.g., the machine learning algorithm). For example, in some embodiments, a cost function for the average difference between computed results obtained from the training set and actual outputs generated by the neural network may be defined. The neural network may be configured to optimize this cost function by tuning the weights for different layers. In other embodiments, the weights may be determined in other ways. Thus, optimized weights to be applied may be determined during training.

Further, in some embodiments, data pre-processing and post-processing may be performed on the inputs and outputs. For example, in some embodiments, inputs/outputs may be convert into standardized or normalized formats. In some embodiments, any non-numeric inputs/outputs may be converted into numeric metrics. Other types of pre-processing on the inputs and post-processing on the outputs may be performed. The process 400 ends at operation 430.

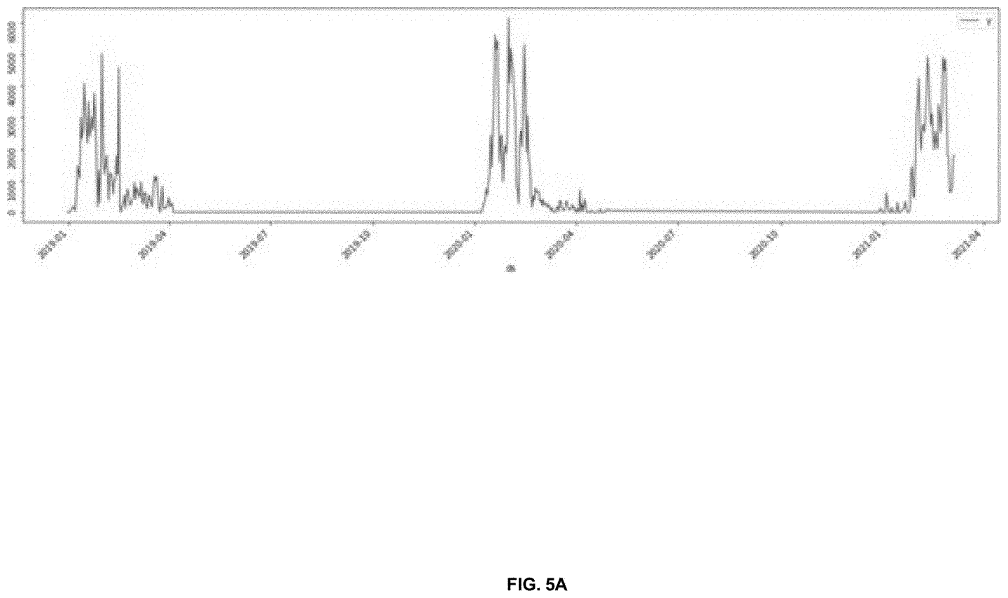

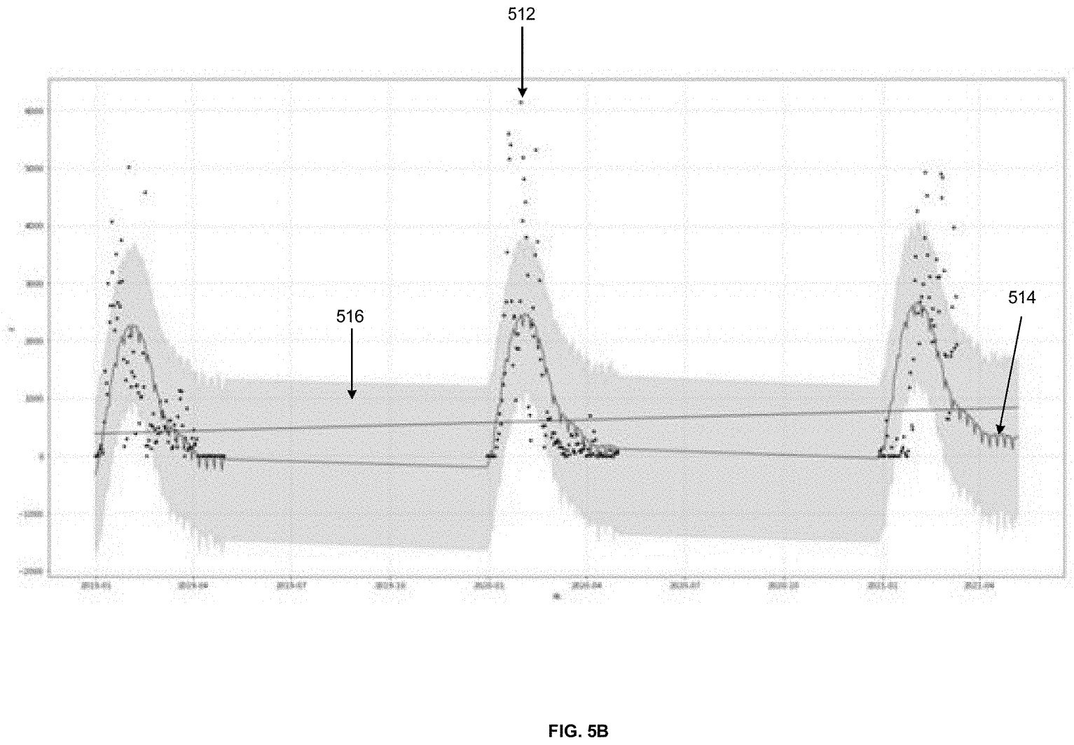

FIG. 5A illustrates an example graph of a volume of the soybeans that has been produced relative to time at an example origination site, in accordance with some embodiments of the present disclosure. The unit of the y-axis may include tons, and the x-axis may include time. Accordingly, the historical volume may provide a big picture of the crop's yield. The volume prediction model 240 may also receive this information and make a prediction of when to harvest the crop in order to maximize the volume. Then the data for the historical volume may be used to make predictions for the future.

FIG. 5B illustrates an example graph predicting a volume of the soybeans based on the historical data from FIG. 5A, in accordance with some embodiments of the present disclosure. The unit of the y-axis may include tons, and the x-axis may include time. The graph of FIG. 5A included historical data up to around March 2021 (“2021-03”). The historical data, the contractual agreement and/or the precipitation levels may be used to predict a future yield of the soybeans as shown in FIG. 5B, including the graph that extends beyond March 2021. Dots 512 may include actual yields that were received and collected on a particular day. A prediction curve 514 may be generated using the historical data represented by the dots 512. And a variance curve 516 may be generated which includes the accuracy of the prediction curve 514 within a certain margin.

FIG. 6 illustrates an example flow chart outlining the operations for predicting a moisture level of the soybeans at an origination site, in accordance with some embodiments of the present disclosure. The process 600 may be performed using the moisture level prediction model 245 by the mix and blend engine 225. It is noted that the process 600 is merely an example, and is not intended to limit the present disclosure. Accordingly, it is understood that additional operations may be provided before, during, and after the process 600 of FIG. 6, and one or more of the operations in the process 600 as shown in FIG. 6 may be removed or modified, depending on embodiments.

The moisture level prediction model 245 may predict the moisture level in soybeans from a particular origination site. The moisture level prediction model 245 may receive historical moisture level data from a first origination site, historical weather data from the first origination site, recent moisture level data at the first origination site, and recent weather data (e.g., precipitation data) at the first origination site.

In some embodiments, ranges (or buckets) of moisture levels may be defined. For example, moisture level of 14% or lower may be classified as “dry,” greater than 14% and less than or equal to 16% may be classified as “wet,” greater than 16% and less than or equal to 19% may be classified as “very wet,” greater than 19% and less than or equal to 22% may be classified as “ultra wet,” and greater than 22% may be classified as out of specification (e.g., unusuable even if dried). The numbers showing the different thresholds are merely an example and embodiments are not limited thereto. There may be more or fewer rangers/buckets, and the thresholds may vary. In some embodiments, the optimization system 200 (and/or the moisture level prediction model 245) may provide a recommendation to dry a particular batch before mixing/blending the batch with other batch(es). For example, if a batch of soybeans is considered very wet (e.g., 16% to 19%), the optimization system 200 may recommend that the batch of soybeans be dried so that the moisture level is dropped to a “wet” range or a “dry” range, before the batch is mixed/blended with the other batch(es). In some embodiments, the optimization system 200 may recommend that a batch of soybeans be discarded because they are too wet to be dried for use, for example if the soybeans have a greater than 22% moisture level.

In some embodiments, the moisture level prediction model 245 may be implemented to include average daily humidity. In some embodiments, the moisture level prediction model 245 may use K-nearest neighbors (KNN) regression based on a series of observed weather data or calculated weather data (e.g., for example for relative humidity). The moisture level prediction model 245 (or the optimization model 200) may compute various correlation measures between the target variable and the above features including their lags and may select the most promising features (e.g., the top 30 features).

At operation 610, the moisture level prediction model 245 may receive as input the historical and recent weather data. The historical weather data may include historical precipitation data, historical humidity data, extreme weather condition data, etc. at or near the origination site over the last X number of years. The current weather data may include similar data but for the most recent number of days or weeks. In some embodiments, the current weather data may be more detailed than the historical weather data.

At operation 615, the moisture level prediction model 245 may receive a historical moisture level data from the first origination site. The moisture level prediction model 245 may correlate how much moisture the soybeans had in the past in relation to the historical and recent weather data (e.g., precipitation data). How much precipitation there was at or near the first origination site over the last X number of days may indicate how much moisture level there is in the soybeans.

At operation 620, the moisture level prediction model 245 may use this historical moisture level data, historical weather data, recent moisture level data, and/or recent weather data to accurately predict the moisture level of the soybeans from the origination site. At operation 625, the moisture level prediction model 245 may output the predicted moisture level of the soybeans to the optimization engine 220. In some embodiments, the moisture level prediction model 245 may be trained similar to the volume prediction model 240, as described above. Further, and similar to the volume prediction model 240, the weights that may be applied to the moisture level prediction model 245 may be adjusted, as well as pre-processing and post-processing may be performed on data. In some embodiments, the moisture level prediction model 245 may make a prediction for each day during the optimization window.

In some embodiments, the moisture level prediction model 245 may receive as input sampling data including moisture levels of samples of the soybeans in the crop that is being collected at the origination site. Then, the moisture level prediction model 245 may then calculate, based on the sampling data, how much moisture level there is for the entire batch. In some embodiments, the sampling may be performed in transit or at an origination site so that the optimization model may be updated. The process 600 ends at operation 630.

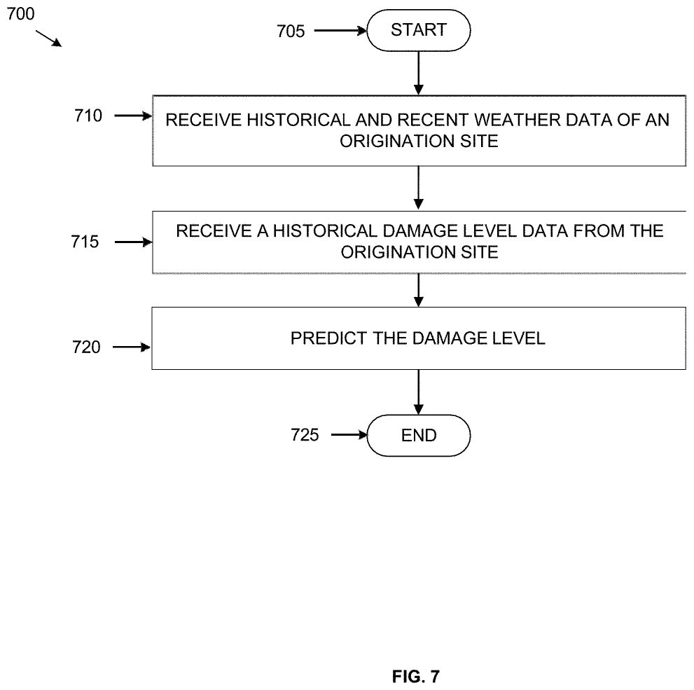

FIG. 7 illustrates an example flow chart outlining the operations for predicting a damage level of the soybeans at an origination site, in accordance with some embodiments of the present disclosure. The process 700 may be performed using the damage level prediction model 250 by the mix and blend engine 225. It is noted that the process 700 is merely an example, and is not intended to limit the present disclosure. Accordingly, it is understood that additional operations may be provided before, during, and after the process 700 of FIG. 7, and one or more of the operations in the process 700 as shown in FIG. 7 may be removed or modified, depending on embodiments.

The damage level prediction model 250 may predict how much damage soybeans from a particular origination site will have. The damage level prediction model 250 may receive historical damage level data from the first origination site, recent damage level data at the origination site, historical weather data from the first origination site, and recent weather data (e.g., precipitation data) at the first origination site.

At operation 710, the damage level prediction model 250 may receive as input the historical and recent weather data. The historical weather data may include historical precipitation data, historical humidity data, historical wind data, extreme weather condition data, etc. at or near the origination site over the last X number of years. The current weather data may include similar data but for the most recent number of days or weeks. In some embodiments, the current weather data may be more detailed than the historical weather data.

At operation 715, the damage level prediction model 250 may receive a historical damage level data from the first origination site. The damage level prediction model 250 may correlate how much damage the soybeans had in the past in relation to the historical and recent weather data (e.g., precipitation data). How much precipitation there was at or near the first origination site over the last X number of days may indicate how much damage level there is in the soybeans. For example, the damage level prediction model 250 may detect a pattern, if any, that correlates the weather data to the historical damage level data.

At operation 720, the damage level prediction model 250 may use this historical damage level data, recent damage level at the origination site, historical weather data, and/or recent weather data to accurately predict the damage level of the soybeans from the origination site. In some embodiments, the damage level prediction model 250 may receive as input sampling data including damage levels of samples of the soybeans in the crop that is being collected at the origination site. Then, the damage level prediction model 250 may then calculate, based on the sampling data, how much damage level there is for the entire batch. In some embodiments, the sampling may be performed in transit or at an origination site so that the optimization model may be updated. In some embodiments, the damage level prediction model 250 may be trained similar to the volume prediction model 240, as described above. Further, and similar to the volume prediction model 240, the weights that may be applied to the damage level prediction model 250 may be adjusted, as well as pre-processing and post-processing may be performed on data. In some embodiments, the damage level prediction model 250 may make a prediction for each day during the optimization window. The process 700 ends at operation 725.

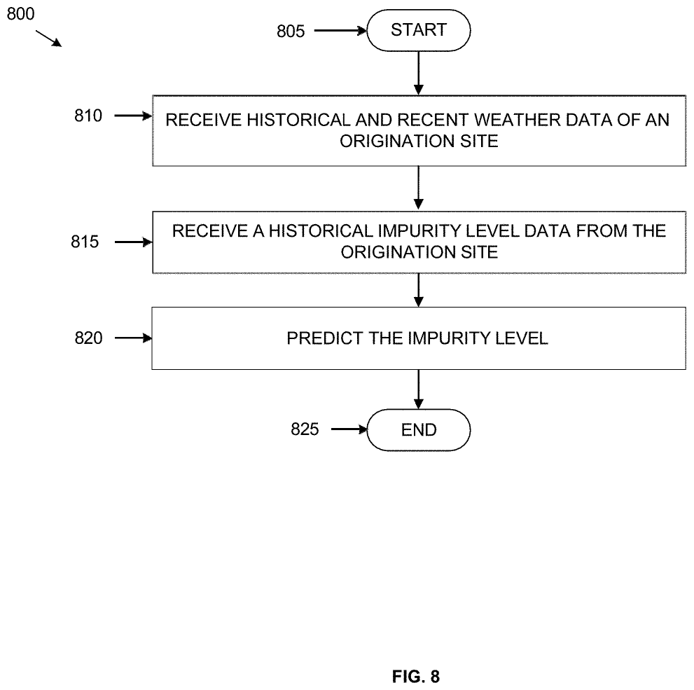

FIG. 8 illustrates an example flow chart outlining the operations for predicting an impurity level of the soybeans at an origination site, in accordance with some embodiments of the present disclosure. The process 800 may be performed using the impurity level prediction model 255 by the mix and blend engine 225. It is noted that the process 800 is merely an example, and is not intended to limit the present disclosure. Accordingly, it is understood that additional operations may be provided before, during, and after the process 800 of FIG. 8, and one or more of the operations in the process 800 as shown in FIG. 8 may be removed or modified, depending on embodiments.

The impurity level prediction model 255 may predict how much impurity soybeans from a particular origination site will have. The impurity level prediction model 255 may receive historical impurity level data from the first origination site, recent impurity level data at the origination site, historical weather data from the first origination site, and recent weather data (e.g., precipitation data) at the first origination site.

At operation 810, the impurity level prediction model 255 may receive as input the historical and recent weather data. The historical weather data may include historical precipitation data, historical humidity data, historical wind data, extreme weather condition data, etc. at or near the origination site over the last X number of years. The current weather data may include similar data but for the most recent number of days or weeks. In some embodiments, the current weather data may be more detailed than the historical weather data.

At operation 815, the impurity level prediction model 255 may receive a historical impurity level data from the first origination site. The impurity level prediction model 255 may correlate how much impurity the soybeans had in the past in relation to the historical and recent weather data (e.g., precipitation data). How much precipitation there was at or near the first origination site over the last X number of days may indicate how much impurity level there is in the soybeans. For example, the impurity level prediction model 255 may detect a pattern, if any, that correlates the weather data to the historical impurity level data. In some embodiments, the impurity level may depend on what type of machinery (e.g., harvesting machinery or transportation vehicles) is used to collect the soybeans. For example, soybeans being harvested with older and/or rougher equipment may be damaged more than newer equipment that may be better equipped to handle smaller grains, for example.

At operation 820, the impurity level prediction model 255 may use this historical impurity level data, historical weather data, and/or recent weather data to accurately predict the impurity level of the soybeans from the origination site. At operation 825, the impurity level prediction model 255 may output the predicted impurity level of the soybeans to the optimization model 220. In some embodiments, the impurity level prediction model 255 may be trained similar to the volume prediction model 240, as described above. Further, and similar to the volume prediction model 240, the weights that may be applied to the impurity level prediction model 255 may be adjusted, as well as pre-processing and post-processing may be performed on data. In some embodiments, the impurity level prediction model 255 may make a prediction for each day during the optimization window. The process 800 ends at operation 825.

In some embodiments, the impurity level prediction model 255 may receive as input sampling data including impurity levels of samples of the soybeans in the crop that is being collected at the origination site. Then, the impurity level prediction model 255 may then calculate, based on the sampling data, how much impurity level there is for the entire batch. In some embodiments, the sampling may be performed in transit or at an origination site so that the optimization model may be updated.

In some embodiments, machine learning may be used to predict the volume (tons) of product (e.g., soybean and corn) that arrives at processing facilities gates (e.g., country elevator gates). The machine learning may use commercial contracts, historical data from the past harvests, and weather condition which leads farmer decisions about whether to ship or not the product to the destinations (e.g., processing facilities). This data may lead the food processor to plan their operations in advance, e.g., 15 days in advance.

In some embodiments, machine learning may be used to predict the quality (e.g., % moisture level) of product (e.g., soybean and corn) arriving at the processing facilities gates (e.g., country elevator gates). The machine learning may use historical data from the past harvests and weather conditions which affects the probability of the amount of moisture of the product. This data may lead the food processor to plan their operation in advance, e.g., 15 days in advance.

In some embodiments, an optimization algorithm, using mixed integer linear programming, may be used for maximizing the cost and benefit of the grain supply chain/network. The algorithm may allow the food processor to optimize the shipment from the processing facility (e.g., country elevator) internally and all the network of all facilities to respectively destinations. This capability may allow the food processor to shift from manual to an automated process leading the facilities to receive more products, reduce the need of dry operation, and maximizing gains with mix and blend (M&B).

In some embodiments, an integrated digital platform for the user may be used. The platform may integrate some or all key stakeholders from the supply chain operation (e.g., operation and supply chain planning and logistic teams). The user interface may give a daily recommendation for each of the many processing facilities (e.g., 80 country elevator facilities) a prescription about: 1) the amount of volume to store; 2) the amount of volume the facility will dry, where to store and where to ship to their destination; 3) allow the operation to configure all their stock at a deep low level of segregation and 4) for the supply chain team, the mixed & blend and shipment recommendation for entire countries. In some embodiments, an integrated digital platform for the user may be used which may integrate all the key stakeholders from the supply chain operation such as operation and supply chain planning, logistic teams, and port operation.

In some embodiments, machine learning may be used to predict the quality (e.g., % damage level) of product (e.g., soybean and corn) arriving at the processing facility gates (e.g., country elevator gates). The machine learning may use historical data from the past harvests and weather condition which indicates the probability of the amount of moisture of the product. This data may lead to the food processor to plan their operation in advance, e.g., 15 days in advance.

In some embodiments, machine learning may be used to predict the quality (e.g., % impurity level) of product (soybean and corn) arriving at the processing facility gates (e.g., country elevator gates). The machine learning may use historical data from the past harvests and weather condition which indicates the probability of the amount of moisture of the product. This data may lead to the food processor to plan their operations in advance, e.g., 15 days in advance.

In some embodiments, the acceptance criteria for impurity levels may be different for the impurity level than for the moisture or damaged levels. In some embodiments, the prediction model(s) for the impurity level may be distinct from the other moisture and damaged quality predicting models. Also, other factors might influence the impurities model than the other models. For example, the type of the harvesting machinery available to various farmers might influence the % of impurities while it may have no influence on moisture or damaged.

In some embodiments, the optimization model may be used to optimize the throughput and mixed & blend inside the ports (e.g., processing facilities, exporting destinations). This capability may allow the food processor to optimize the entire supply chain from the processing facilities (e.g., the country elevators) operation until arriving ships are inside the ports, increasing even more products (e.g., grain with mixed & blend).

In some embodiments, the optimization model may give the entire country elevator operation an hourly recommendation. For example, the optimization model may optimize the flow inside the facility in case there is an equipment under maintenance. In some embodiments, operations can change with more frequency during the day and in an hourly basis decision around when and how to dry, store and ship the soybeans.

In some embodiments, the optimization system may be employed with technology including Internet of Things (IoT), e.g., using CO2 sensors, to automate the stocks status (e.g., volumes and qualities) that may allow reduction or elimination of any human interaction with the tools and/or equipment to obtain the stock information (e.g., inputs to the mix and blend engine 225). In some embodiments, the prediction model(s) may be used together with the IoT sensors to predict the level of product damage in a timeline which may allow the optimization system to give a prediction for the operation team to ship in advance, minimizing financial losses related to the product.

In some embodiments, the optimization model may provide recommendations on a frequent basis (e.g., daily, half-daily, hourly, etc.) for all of the processing facilities in the network or a country. In some embodiments, the optimization model may receive as input that a piece of equipment (e.g., mixer, dryer, etc.) is under maintenance. Then, the optimization model may recommend that soybeans be directed to other facilities. In some embodiments, the optimization model may use sensors (e.g., CO2 sensors) to receive as input the current status of soybeans at the various facilities. Furthermore, sensors may be used to determine or predict the damage level of the soybeans.

The various illustrative logical blocks, circuits, modules, routines, and algorithm steps described in connection with the embodiments disclosed herein may be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality may be implemented in varying ways for each particular application, but such implementation decisions should not be interpreted as causing a departure from the scope of the disclosure.

Moreover, the various illustrative logical blocks and modules described in connection with the embodiments disclosed herein may be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor may synthesize a model for an FPGA. For example, the control processor may synthesize a model for logical programmable gates to implement a tensor array and/or a pixel array. The control channel may synthesize a model to connect the tensor array and/or pixel array on an FPGA, a reconfigurable chip and/or die, and/or the like. A general purpose processor device may be a microprocessor, but in the alternative, the processor device may be a controller, microcontroller, or state machine, combinations of the same, or the like. A processor device may include electrical circuitry configured to process computer-executable instructions. In another embodiment, a processor device includes an FPGA or other programmable device that performs logic operations without processing computer-executable instructions. A processor device may also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment may include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein may be embodied directly in hardware, in a software module executed by a processor device, or in a combination of the two. A software module may reside in RAM memory, flash memory, ROM memory, EPROM memory, EEPROM memory, registers, hard disk, a removable disk, a CD-ROM, or any other form of a non-transitory computer-readable storage medium. An exemplary storage medium may be coupled to the processor device such that the processor device may read information from, and write information to, the storage medium. In the alternative, the storage medium may be integral to the processor device. The processor device and the storage medium may reside in an ASIC. The ASIC may reside in a user terminal. In the alternative, the processor device and the storage medium may reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it may be understood that various omissions, substitutions, and changes in the form and details of the devices or algorithms illustrated may be made without departing from the spirit of the disclosure. As may be recognized, certain embodiments described herein may be embodied within a form that does not provide all of the features and benefits set forth herein, as some features may be used or practiced separately from others.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected,” or “operably coupled,” to each other to achieve the desired functionality, and any two components capable of being so associated may also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method comprising:
predicting, by a processor executing computer-readable instructions, a volume of a product from each of a plurality of origination sites;
predicting, by the processor, a quality of the product from each of the plurality of origination sites;
determining, by the processor, one or more constraints for blending the product from the plurality of origination sites to obtain a blended product, wherein the one or more constraints comprises at least a desired combined volume and a quality level; and
generating, by the processor, a total volume of the product to be used from at least one of the plurality of origination sites for obtaining the blended product such that the blended product is of the desired combined volume and the quality level, wherein the total volume is determined based on the predicted volume of the product and the predicted quality of the product from each of the plurality of origination sites.

2. The method of claim 1, wherein predicting the volume of the product from an origination site of the plurality of origination sites comprises:
receiving, by the processor, a historical volume of the product from the origination site;
receiving, by the processor, a contractual agreement that indicates an amount of the product to be provided by the origination site;
receiving, by the processor, weather data related to the origination site; and
determining, by the processor, using a machine learning model the volume of the product at the origination site based on the historical data, the contractual agreement, and the weather data.

3. The method of claim 1, wherein the volume of the product and the quality of the product are predicted for each day over an optimization window for each of the plurality of origination sites.

4. The method of claim 1, wherein generating the total volume of the product comprises combining a first volume of the product from a first origination site of the plurality of origination sites with a second volume of the product from a second origination site of the plurality of origination sites.

5. The method of claim 4, wherein the first volume and the second volume are received on different days.

6. The method of claim 1, wherein predicting the quality level comprises predicting one or more of a damage level, an impurity level, or a moisture level of the product.

7. The method of claim 6, further comprising:
determining, by the processor, the moisture level of the product from an origination site of the plurality of origination sites;
comparing, by the processor, the moisture level with a threshold moisture level; and
designating, by the processor, the product from the origination site for additional drying upon determining that the moisture level is greater than the threshold moisture level.

8. The method of claim 1, wherein generating the total volume of the product is based on a mixed integer linear programming model.

9. A non-transitory computer-readable medium having computer-executable instructions stored thereon that when executed by at least one processor, cause the at least one processor to:
predict a volume of a product from each of a plurality of origination sites;
predict a quality of the product from each of the plurality of origination sites;
determine one or more constraints for blending the product from the plurality of origination sites to obtain a blended product, wherein the one or more constraints comprises at least a desired combined volume and a quality level; and
generate a total volume of the product to be used from at least one of the plurality of origination sites for obtaining the blended product such that the blended product is of the desired combined volume and the quality level, wherein the total volume is determined based on the predicted volume of the product and the predicted quality of the product from each of the plurality of origination sites.

10. The non-transitory computer-readable medium of claim 9, wherein the at least one processor further executes computer-executable instructions to:
receive a historical volume of the product from the origination site;
receive a contractual agreement that indicates an amount of the product to be provided by the origination site;
receive weather data related to the origination site; and
determine using a machine learning model the volume of the product at the origination site based on the historical data, the contractual agreement, and the weather data.

11. The non-transitory computer-readable medium of claim 9, wherein the volume of the product and the quality of the product are predicted for each day over an optimization window for each of the plurality of origination sites.

12. The non-transitory computer-readable medium of claim 9, wherein the at least one processor further executes computer-executable instructions to combine a first volume of the product from a first origination site of the plurality of origination sites with a second volume of the product from a second origination site of the plurality of origination sites.

13. The non-transitory computer-readable medium of claim 12, wherein the first volume and the second volume are received on different days.

14. The non-transitory computer-readable medium of claim 9, wherein predicting the quality level comprises predicting one or more of a damage level, an impurity level, or a moisture level of the product.

15. The non-transitory computer-readable medium of claim 14, wherein the at least one processor further executes computer-executable instructions to:
determine the moisture level of the product from an origination site of the plurality of origination sites;
compare the moisture level with a threshold moisture level; and
designate the product from the origination site for additional drying upon determining that the moisture level is greater than the threshold moisture level.

16. A system comprising:
a memory having computer-executable instructions stored thereon; and
a processor that executes the computer-executable instructions to:
predict a volume of a product from each of a plurality of origination sites;
predict a quality of the product from each of the plurality of origination sites;
determine one or more constraints for blending the product from the plurality of origination sites to obtain a blended product, wherein the one or more constraints comprises at least a desired combined volume and a quality level; and
generate a total volume of the product to be used from at least one of the plurality of origination sites for obtaining the blended product such that the blended product is of the desired combined volume and the quality level, wherein the total volume is determined based on the predicted volume of the product and the predicted quality of the product from each of the plurality of origination sites.

17. The system of claim 16, wherein the processor further executes computer-executable instructions to:
receive a historical volume of the product from the origination site;
receive a contractual agreement that indicates an amount of the product to be provided by the origination site;
receive weather data related to the origination site; and
determine using a machine learning model the volume of the product at the origination site based on the historical data, the contractual agreement, and the weather data.

18. The system of claim 16, wherein the volume of the product and the quality of the product are predicted for each day over an optimization window for each of the plurality of origination sites.

19. The system of claim 18, wherein the processor further executes computer-executable instructions to combine a first volume of the product from a first origination site of the plurality of origination sites with a second volume of the product from a second origination site of the plurality of origination sites.

20. The system of claim 16, wherein predicting the quality level comprises predicting one or more of a damage level, an impurity level, or a moisture level of the product, and wherein the processor further executes computer-executable instructions to:
determine the moisture level of the product from an origination site of the plurality of origination sites;
compare the moisture level with a threshold moisture level; and
designate the product from the origination site for additional drying upon determining that the moisture level is greater than the threshold moisture level.
